(19) United States
(12) Patent Application Publication
(10) Pub. No.: US 2025/0139710 A1
(43) Pub. Date: May 1, 2025

(54) SETTLEMENT TERMINAL OPERATION SYSTEM

(71) Applicant: TOSHIBA TEC KABUSHIKI KAISHA, Tokyo (JP)

(72) Inventor: Aoki Hiroyasu, Izu Shizuoka (JP)

(21) Appl. No.: 18/660,259

(22) Filed: May 10, 2024

(30) Foreign Application Priority Data
Nov. 1, 2023 (JP) 2023-187352

(51) Int. Cl. G06Q 40/12

(52) U.S. Cl. CPC G06Q 40/12

(57) ABSTRACT

A settlement terminal operation system includes a settlement terminal configured to execute settlement and a portable terminal configured to operate the settlement terminal. The settlement terminal includes a settlement processing unit, a daily account processing unit, and a first communication control unit. The settlement processing unit executes, by communication with a settlement server, settlement for paying a price. The daily account processing unit executes account daily processing for tallying settlements executed within a period by the settlement processing unit. The first communication control unit executes communication with the portable terminal. The portable terminal includes an operation control unit and a second communication control unit. The operation control unit receives operation for causing the settlement terminal to execute the daily account processing. If the operation was received by the operation control unit, the second communication control unit transmits a daily account processing command for requesting execution of the daily account processing.

### CROSS-REFERENCE TO RELATED APPLICATION

This application is based upon and claims the benefit of priority from Japanese Patent Application No. 2023-187352, filed on Nov. 1, 2023, the entire contents of which are incorporated herein by reference.

### FIELD

Embodiments described herein relate generally to a settlement terminal operation system and methods related thereto.

### BACKGROUND

In a retail store, a settlement terminal that executes settlement relating to a transaction has been conventionally used. The settlement terminal executes, almost every day, daily account processing for tallying settlements of the day. The daily account processing is often required to be executed at substantially the same time.

However, a person in charge has to, almost every day, at substantially the same time, go to a place where the settlement terminal is installed and execute settlement processing. This was troublesome for the person in charge.

### BRIEF DESCRIPTION OF THE DRAWINGS

FIG. 1 is a block diagram illustrating an example of a settlement system according to an embodiment;

FIG. 2 is a diagram illustrating an example of a hardware configuration of a settlement terminal;

FIG. 3 is a diagram illustrating an example of a hardware configuration of a portable terminal;

FIG. 4 is a block diagram illustrating an example of functional components included in the settlement terminal and the portable terminal;

FIG. 5 is a diagram illustrating an example of a selection image;

FIG. 6 is a diagram illustrating an example of a registration image;

FIG. 7 is a diagram illustrating an example of an execution image;

FIG. 8 is a diagram illustrating an example of an execution result image;

FIG. 9 is a flowchart illustrating an example of transaction processing according to the embodiment; and

FIG. 10 is a flowchart illustrating an example of remote daily account processing according to the embodiment.

### DETAILED DESCRIPTION

An aspect of embodiments is to provide a settlement terminal operation system that can reduce a burden on daily account processing.

A settlement terminal operation system according to an embodiment includes: a settlement terminal configured to execute settlement; and a portable terminal configured to operate the settlement terminal. The settlement terminal includes a settlement processing unit, a daily account processing unit, and a first communication control unit. The settlement processing unit executes, by communication with a settlement server, settlement for paying a price. The daily account processing unit executes daily account processing for tallying settlements executed within a period by the settlement processing unit. The first communication control unit executes communication with the portable terminal. The portable terminal includes an operation control unit and a second communication control unit. The operation control unit receives operation for causing the settlement terminal to execute the daily account processing. If the operation was received by the operation control unit, the second communication control unit transmits a daily account processing command for requesting execution of the daily account processing.

An embodiment of a settlement terminal operation system is explained in detail below with reference to the accompanying drawings. Note that the embodiment explained below is an embodiment of the settlement terminal operation system and does not limit a configuration, specifications, and the like of the settlement terminal operation system.

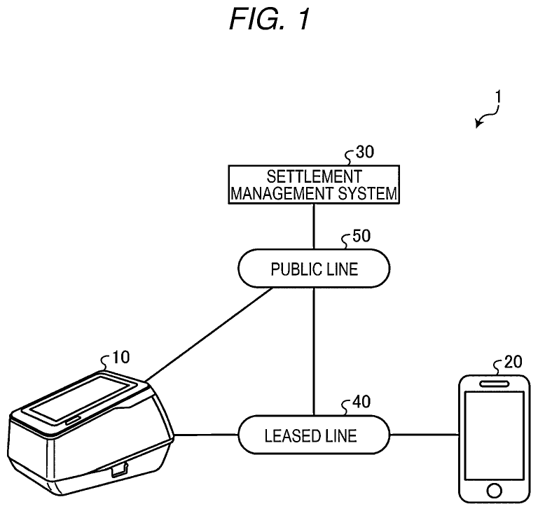

FIG. 1 is a block diagram illustrating an example of a settlement system 1 according to this embodiment. The settlement system 1 includes a settlement terminal 10 and a portable terminal 20. The settlement system 1 is connected to a settlement management system 30 via a leased line 50. The settlement terminal 10 that executes settlement and a portable terminal 20 that operates the settlement terminal 10 are examples of the settlement terminal operation system.

The settlement terminal 10 is communicably connected to the portable terminal 20 via a public line 40 such as the Internet. The settlement terminal 10 is communicably connected to the settlement management system 30 via the leased line 50. Further, the settlement terminal 10 and the portable terminal 20 may be communicably connected to the settlement management system 30 by virtually constructing, with a VPN (Virtual Private Network), a dedicated line in the public line 40.

Note that the settlement system 1 illustrated in FIG. 1 is an example. That is, the settlement system 1 may include apparatuses and systems not illustrated in FIG. 1. Further, the settlement system 1 may include a plurality of settlement terminals 10 and a plurality of portable terminals 20.

The settlement management system 30 includes a plurality of settlement servers that manage settlement by the settlement terminal 10. For example, the settlement management system 30 includes a credit center server that manages settlement by a credit card, a slip storage center that manages slips, a point company server that manages a point granted by settlement, an electronic money center server that manages settlement by electronic money, and a maintenance server that distributes a program of the settlement terminal 10. Note that the settlement management system 30 may include not all of the servers and may include servers other than these servers.

The settlement terminal 10 is an apparatus that executes settlement for paying a price in a transaction. For example, the settlement terminal 10 is an apparatus that executes checkout processing by a credit card, electronic money, or the like. The settlement terminal 10 executes daily account processing for tallying settlements of the day. The settlement terminal 10 may execute the daily account processing according to remote operation.

The portable terminal 20 is a portable apparatus such as a smartphone or a tablet terminal. The portable terminal 20 causes, according to remote operation, the settlement terminal 10 to execute the daily account processing.

Next, hardware configurations of the settlement terminal 10 and the portable terminal 20 included in the settlement system 1 are explained.

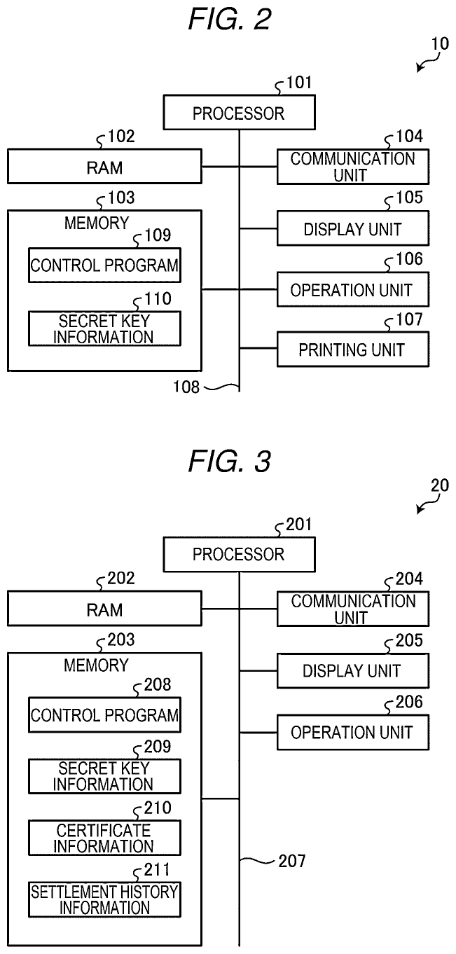

FIG. 2 is a diagram illustrating an example of the hardware configuration of the settlement terminal 10. The settlement terminal 10 includes a processor 101, a RAM (Random Access Memory) 102, a memory 103, a communication unit 104, a display unit 105, an operation unit 106, and a printing unit 107. These units are connected to one another via a system bus 108 such as a data bus or an address bus.

The processor 101 is a processing circuit such as a CPU (Central Processing Unit) that controls an operation of the settlement terminal 10. The processor 101 executes a control program 109 and the like stored in the memory 103 using the RAM 102 as a work area.

The memory 103 is a storage device such as a HDD (Hard Disk Drive), an SSD (Solid State Drive), or a flash memory. The memory 103 stores the control program 109 and secret key information 110.

The control program 109 is an operating system or a program for exerting functions of the settlement terminal 10. The control program 109 includes a program for exerting characteristic functions according to this embodiment.

The secret key information 110 is a secret key of the settlement terminal 10. More specifically, the secret key information 110 is information serving as a key for decrypting information encrypted by a public key in a public key cryptosystem.

The communication unit 104 is an interface for executing communication with an external apparatus via a network. For example, the communication unit 104 is an NIC (Network Interface Card).

The display unit 105 is a display device that displays various images. For example, the display unit 105 is a liquid crystal display.

The operation unit 106 is an input device that receives various kinds of operation. For example, the operation unit 106 is hardware buttons or a touch panel provided on the display unit 105.

The printing unit 107 prints, on paper, a receipt or the like showing transaction content, a point status, and the like. The printing unit 107 prints, on paper, a processing result of daily account processing.

FIG. 3 is a diagram illustrating an example of a hardware configuration of the portable terminal 20. The portable terminal 20 includes a processor 201, a RAM 202, a memory 203, a communication unit 204, a display unit 205, and an operation unit 206. These units are connected to one another via a system bus 207 such as a data bus or an address bus.

The processor 201 is a processing circuit such as a CPU that controls an operation of the portable terminal 20. The RAM 202 is a storage medium that temporarily stores various programs and various data. The processor 201 executes a control program 208 and the like stored in the memory 203 using the RAM 202 as a work area.

The memory 203 is a storage device such as a HDD, an SSD, or a flash memory. The memory 203 stores the control program 208, public key information 209, certificate information 210, and settlement history information 211. Note that all or a part of the public key information 209, the certificate information 210, and the settlement history information 211 may be stored not only in the memory 203 but also in a storage medium of another apparatus.

The control program 208 is an operating system or a program for exerting functions of the portable terminal 20. The control program 208 includes a program for exerting characteristic functions according to this embodiment.

The public key information 209 is a public key of the settlement terminal 10. More specifically, the public key information 209 is information serving as a key for encrypting information to be transmitted to the settlement terminal 10. For example, the public key information 209 is used for encryption of the certificate information 210.

The certificate information 210 is information for proving that the portable terminal 20 is registered. In other words, the certificate information 210 is information for proving that the portable terminal 20 has authority to execute daily account processing. The certificate information 210 includes authentication information, random number data, and expiration date information. The authentication information is information for identifying an authenticated portable terminal 20. For example, the authentication information is identification information for specifying the portable terminal 20. Specifically, the authentication information is an IP (Internet Protocol) C (Media Access Control) address of the portable terminal 20. The authentication information may be information indicating that an operator who operates the portable terminal 20 is an authenticated user. The random number data is data of a random number. The random number data is used to generate a communication key used for communication between the settlement terminal 10 and the portable terminal 20. The expiration data information is information indicating an expiration date of the certificate information 210.

The settlement history information 211 is a history of settlement content such as credit settlement or electronic money settlement. The settlement history information 211 includes settlement date and time information and settlement content information. The settlement date and time information is information indicating a date and time when settlement such as credit settlement or electronic money settlement was executed. The settlement content information is information indicating settlement content. For example, the settlement content information includes settlement company identification information, transaction content information, payment method information, and the like. The settlement company identification information is identification information for specifying a settlement company that performs a business such as credit settlement or electronic money settlement. The transaction content information is information concerning an amount of sales indicating that a price was received and an amount of cancellation and return of goods indicating that a price was returned. The payment method information is information concerning a method of payment from a customer to the settlement company such as lump sum payment, bonus payment, and payment in installments.

The communication unit 204 is an interface that executes communication with an external apparatus via a network. For example, the communication unit 204 is an NIC.

The display unit 205 is a display device that displays various images. For example, the display unit 205 is a liquid crystal display.

The operation unit 206 is an input device that receives various kinds of operation. For example, the operation unit 206 is hardware buttons or a touch panel provided on the display unit 205.

Next, functions included in the settlement terminal 10 are explained.

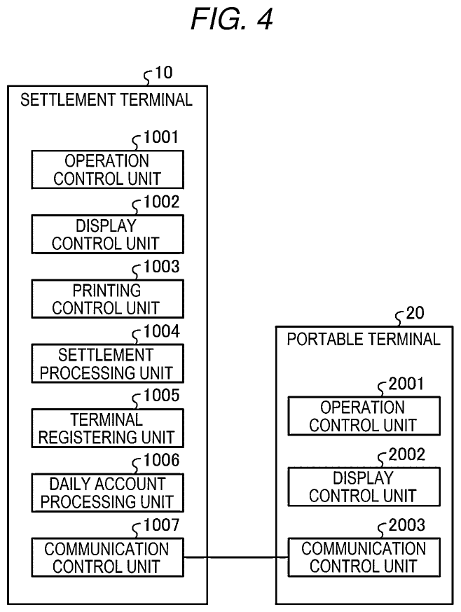

FIG. 4 is a block diagram illustrating an example of functional components included in the settlement terminal 10 and the portable terminal 20. The processor 101 included in the settlement terminal 10 loads, in the RAM 102, the control program 109 stored in the memory 103 and operates according to the control program 109 to generate various functional units in the RAM 102. Accordingly, the processor 101 included in the settlement terminal 10 includes, as the functional units, an operation control unit 1001, a display control unit 1002, a printing control unit 1003, a settlement processing unit 1004, a terminal registration unit 1005, a daily account processing unit 1006, and a communication control unit 1007.

The operation control unit 1001 controls the operation unit 106 to receive various kinds of operation. For example, the operation control unit 1001 receives operation concerning settlement processing for paying a price and operation concerning daily account processing.

The display control unit 1002 displays various images on the display unit 105. For example, the display control unit 1002 displays an image concerning settlement processing for paying a price and an image concerning daily account processing.

The printing control unit 1003 controls the printing unit 107 to print various kinds of information. For example, the printing control unit 1003 prints a receipt relating to one transaction according to settlement processing. The receipt includes information concerning the settlement processing. For example, the receipt includes a settlement company, a payment method such as lump sum payment, bonus payment, or payment by installments, an amount, and the like.

The printing control unit 1003 prints, on paper such as a receipt, a settlement processing result of settlement processing executed by the settlement processing unit 1004.

The settlement processing unit 1004 executes, by communication with a settlement included in the settlement management system 30, settlement for paying a price. For example, the settlement processing unit 1004 executes credit settlement or electronic money settlement by the communication with the settlement server.

If the settlement processing unit 1004 executed settlement such as credit settlement or electronic money settlement, the settlement processing unit 1004 registers, in the settlement history information 211, settlement date and time information indicating a settlement date and time and settlement content information indicating settlement content in correlation with each other.

The terminal registration unit 1005 registers the portable terminal 20 that instructs execution of daily account processing. In other words, the terminal registration unit 1005 registers information concerning the portable terminal 20 having authority to cause the settlement terminal 10 to execute the daily account processing. The terminal registration unit 1005 is an example of the registration unit. For example, the information concerning the portable terminal 20 includes identification information for specifying the portable terminal 20 that requests authentication and a public key of the portable terminal 20 in a public key cryptography. For example, the identification information may be an IP (Internet Protocol) address of the portable terminal 20. A MAC (Media Access Control) address may be registered or other identification information may be registered as the identification information.

More specifically, if a registration command was received by the communication control unit 1007, the terminal registration unit 1005 registers the portable terminal 20 specified by information concerning the portable terminal 20 included in the registration command. That is, the terminal registration unit 1005 registers identification information for specifying the portable terminal 20 and a public key. Accordingly, the terminal registration unit 1005 registers the portable terminal 20 having authority to cause the settlement terminal 10 to execute daily account processing.

The daily account processing unit 1006 executes daily account processing for tallying settlements executed within a specified period by the settlement processing unit 1004. More specifically, the daily account processing unit 1006 executes, based on the settlement history information 211, daily account processing for tallying settlements on a day to which time when settlement processing is executed belongs. Note that the specified period is any period. For example, the specified period may be a day to which time when the daily account processing is executed belongs, may be a period from first designated time to second designated time, or may be another period. Further, the specified period may be a period including a plurality of days such as one week or one month.

The daily account processing means processing for tallying, for each settlement company, settlements executed within the specified period by the settlement processing unit 1004. The daily account processing includes details setting and summary setting.

The details setting is processing for tallying details of settlements of respective transactions. If the daily account processing unit 1006 executed the daily account processing with the details setting, the daily account processing unit 1006 outputs a daily account processing result in which details of settlements for paying prices in respective transactions are arranged.

In the settlements for paying the prices in the respective transactions, the summary setting outputs a daily account processing result including a summary for each payment method for a customer to make payment to a settlement company. For example, the daily account processing result includes sales indicating that a price was received and cancellation and return of goods indicating that a price was returned. The daily account processing unit 1006 tallies, for each of the sales and the cancelation and return of goods, the number of events and an amount for each of payment methods such as lump sum payment, bonus payment, and payment by installments.

The daily account processing unit 1006 outputs the daily account processing result generated by the daily account processing. For example, the daily account processing unit 1006 outputs the daily account processing result by causing the communication control unit 1007 to transmit the daily account processing result or causing the printing control unit 1003 to print the daily account processing result.

The communication control unit 1007 controls the communication unit 104 to execute communication with external equipment. For example, the communication control unit 1007 executes communication with the settlement management system 30 via the leased line 50. More specifically, the communication control unit 1007 executes, with the settlement server included in the settlement management system 30, communication concerning settlement for paying a price.

For example, the communication control unit 1007 executes communication with the portable terminal 20 via the public line 40. The communication control unit 1007 is an example of the first communication control unit. More specifically, the communication control unit 1007 executes communication with the portable terminal 20 according to the public key cryptosystem. That is, the communication control unit 1007 executes communication if the portable terminal 20 was authenticated by the certificate information 210. For example, the communication control unit 1007 receives a registration command for registering the portable terminal 20 having authority to cause the settlement terminal 10 to execute daily account processing. The communication control unit 1007 receives a daily account processing command for requesting execution of the daily account processing. The communication control unit 1007 transmits an execution result of the daily account processing.

Next, functions included in the portable terminal 20 are explained.

The processor 201 included in the portable terminal 20 loads, in the RAM 202, the control program 208 stored in the memory 203 and operates according to the control program 208 to generate functional units in the RAM 202. Accordingly, the processor 201 included in the portable terminal 20 includes an operation control unit 2001, a display control unit 2002, and a communication control unit 2003 as the functional units.

The operation control unit 2001 receives various kinds of operation from the operation unit 206. For example, the operation control unit 2001 receives operation concerning daily account processing of the settlement terminal 10.

The display control unit 2002 displays various images on the display unit 205. For example, the display control unit 2002 displays a daily account processing selection image G1.

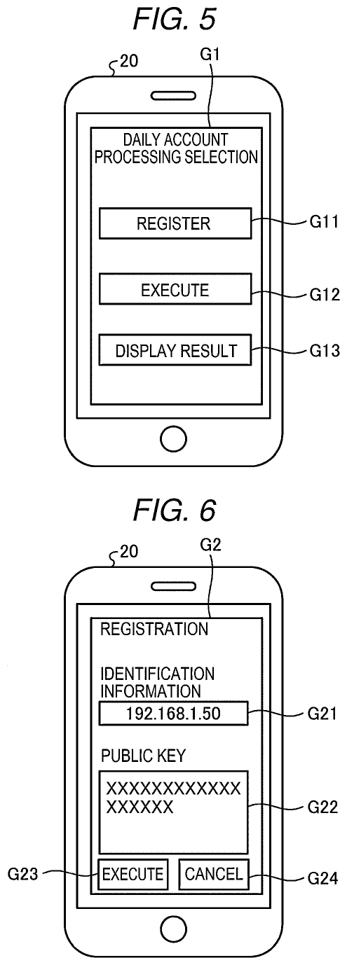

FIG. 5 is a diagram illustrating an example of the daily account processing selection image G1. The daily account processing selection image G1 is an image for receiving selection of functions that the processor 201 causes the portable terminal 20 to execute among functions concerning daily account processing executable by the portable terminal 20. The daily account processing selection image G1 includes a registration button G11, an execution button G12, and a result display button G13.

The registration button G11 is a button for receiving operation for displaying a registration image G2 (see FIG. 5) for registering the portable terminal 20 having authority to execute daily account processing. The execution button G12 is a button for receiving operation for causing the settlement terminal 10 to execute the daily account processing. The execution button G12 is a button for receiving operation for displaying an execution image G3 (see FIG. 6) showing a state of the daily account processing. That is, the operation control unit 2001 receives, according to pressing of the execution button G12, operation for causing the settlement terminal 10 to execute the daily account processing. The result display button G13 is a button for receiving operation for displaying an execution result image G4 (see FIG. 8) including an execution result of the daily account processing.

FIG. 6 is a diagram illustrating an example of the registration image G2. The registration image G2 is an image for registering information concerning the portable terminal 20 having authority to execute daily account processing. The registration image G2 includes an identification information input field G21, a public key input field G22, an execution button G23, and a cancellation button G24. The identification information input field G21 is a field to which identification information for specifying the portable terminal 20 is input. In other words, the identification information input field G21 is a field to which identification information for specifying the portable terminal 20 that requests authentication is input. The public key input field G22 is a field to which a public key of the portable terminal 20 is input. The execution button G23 is a button for receiving operation for registering the identification information input to the identification information input field G21 and the public key input to the public key input field G22. As explained above, the operation control unit 2001 receives information concerning the portable terminal 20 having the authority to cause the settlement terminal 10 to execute the daily account processing. The operation control unit 2001 is an example of the receiving unit.

If the execution button G23 was pressed, the communication control unit 2003 transmits, to the settlement terminal 10, a registration command including the identification information input to the identification information input field G21 and the public key input to the public key input field G22. The terminal registration unit 1005 of the settlement terminal 10 registers the identification information and the public key included in the registration command. Accordingly, the portable terminal 20 is registered as the portable terminal 20 having authority to execute daily account processing. The cancellation button G24 is a button for receiving operation for cancelling the registration of the identification information input to the identification information input field G21 and the public key input to the public key input field G22.

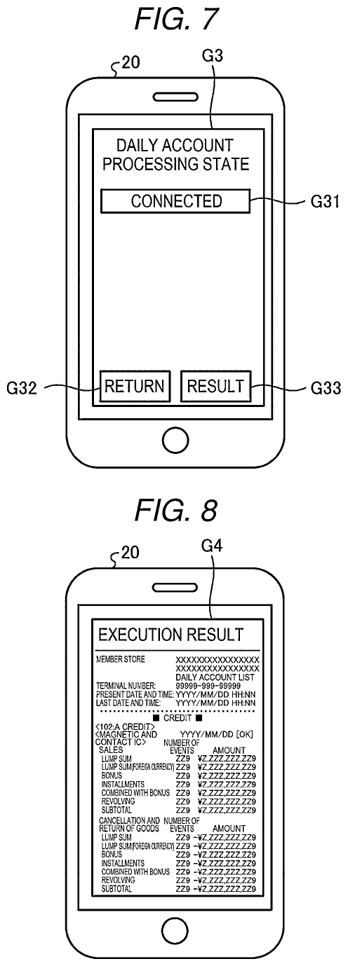

FIG. 7 is a diagram illustrating an example of the execution image G3. The execution image G3 is an image showing a state of daily account processing. The execution image G3 includes a state display field G31, a return button G32, and a result button G33. The state display field G31 is a field in which the state of the daily account processing is displayed. The state display field G31 is a field in which the state of the daily account processing such as connected, authentication being processed, command being transmitted, data being received, normal end, or an error is displayed. In the case of the error, an error code for specifying content of the error is displayed in the state display field G31.

The display control unit 2002 displays a state of daily account processing in the state display field G31 based on a communication log of the communication control unit 2003. That is, the display control unit 2002 displays, in the state display field G31, a state of the daily account processing specified by communication content indicated by the communication log.

The return button G32 is a button for receiving operation for displaying the daily account processing selection image G1. The result button G33 is a button for receiving operation for displaying an execution result of daily account processing. In other words, the result button G33 is also a button for receiving operation for displaying the execution result image G4 (see FIG. 8).

FIG. 8 is a diagram illustrating an example of the execution result image G4. The execution result image G4 is an image including a daily account processing result. That is, the display control unit 2002 displays a processing result of daily account processing on the display unit 205. The daily account processing result illustrated in FIG. 8 indicates an execution result of the daily account processing set as a summary. The execution result image G4 illustrated in FIG. 8 includes a daily account processing result indicating, for each of sales and cancellation and return of goods, the number of events and an amount for each payment method.

The communication control unit 2003 controls the communication unit 204 to execute communication with external equipment. For example, the communication control unit 2003 executes communication with the settlement terminal 10 via the public line 40.

More specifically, the communication control unit 2003 executes communication with the settlement terminal 10 according to the public key cryptosystem. For example, if the operation control unit 2001 received operation for executing daily account processing according to pressing of the execution button G12 of the daily account processing selection image G1, the communication control unit 2003 transmits the certificate information 210 to the portable terminal 20 to thereby request authentication. If being authenticated by the portable terminal 20, the communication control unit 2003 transmits a daily account processing command for requesting execution of the daily account processing. The communication control unit 2003 is an example of the second communication control unit.

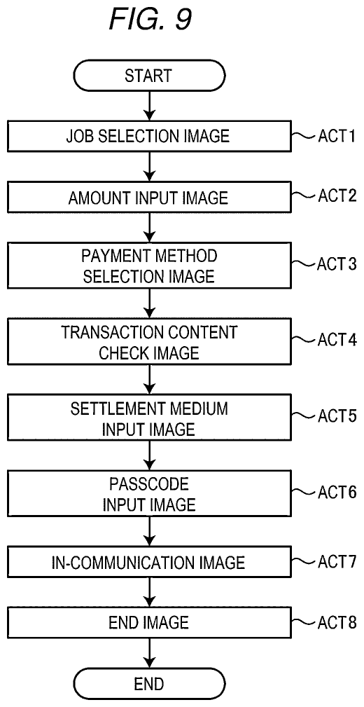

Next, transaction processing executed by the settlement terminal 10 is explained. FIG. 9 is a flowchart illustrating an example of transaction processing according to this embodiment.

The display control unit 1002 displays a job selection screen for causing a user, who operates the settlement terminal 10, to select a job to be performed by the user (Act 1). The operation control unit 1001 receives operation for selecting settlement processing for paying a price in the job selection image.

The display control unit 1002 displays an amount input image for receiving an amount of a price (Act 2). The operation control unit 1001 receives input for designating the amount of the price.

The display control unit 1002 displays a payment method selection image for receiving selection of a method of payment of a customer to a settlement company (Act 3). The operation control unit 1001 receives input for designating a payment method.

The display control unit 1002 displays a transaction content check image including a list of transaction contents of commodities, services, and the like to be targets of settlement processing (Act 4). The operation control unit 1001 receives operation indicating that the list of the transaction contents was checked.

The display control unit 1002 displays a settlement medium input image for urging the customer to input information included in a settlement medium such as a card to the settlement terminal 10 (Act 5).

The display control unit 1002 displays a passcode input screen for receiving input of a passcode of the settlement medium (Act 6). The operation control unit 1001 receives the input of the passcode.

The display control unit 1002 displays in- communication image indicating that the settlement terminal 10 is communicating with the settlement server of the settlement management system 30 (Act 7).

The display control unit 1002 displays an end image indicating that the communication with the settlement server of the settlement management system 30 ended (Act 8).

Then, the settlement terminal 10 ends the transaction processing.

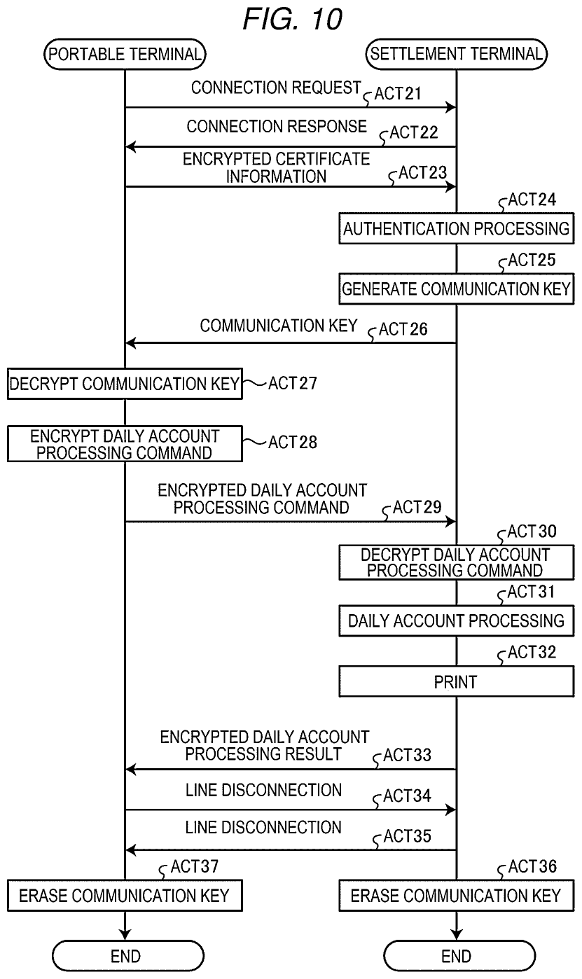

Next, remote daily account processing executed by the settlement terminal 10 and the portable terminal 20 is explained. FIG. 10 is a flowchart illustrating an example of the remote daily account processing according to this embodiment.

The remote daily account processing is processing executed if the execution button G12 of the daily account processing selection image G1 was pressed. The display control unit 2002 of the portable terminal 20 displays, in the state display field G31, the execution image G3 of a state of daily account processing based on a communication log of communication via the public line 40 in the remote daily account processing.

The communication control unit 2003 of the portable terminal 20 transmits, to the settlement terminal 10, a connection request for requesting connection to the portable terminal 20 (Act 21). For example, the communication control unit 2003 transmits a connection request for requesting connection by the TCP (Transmission Control Protocol).

The communication control unit 1007 of the settlement terminal 10 transmits, to the portable terminal 20, a connection response for answering that the communication control unit 1007 connects the settlement terminal 10 according to the connection request (Act 22).

The communication control unit 2003 of the portable terminal 20 transmits, to the settlement terminal 10, the certificate information 210 encrypted by the public key information 209 that is the public key of the settlement terminal 10 (Act 23).

The communication control unit 1007 of the settlement terminal 10 executes authentication processing for the portable terminal 20 based on the received certificate information 210 (Act 24). The communication control unit 1007 determines, according to the expiration date information included in the certificate information 210 decrypted by the secret key of the settlement terminal 10, whether the expiration date of the certificate information 210 expired. The communication control unit 1007 compares the authentication information included in the certificate information 210 decrypted by the secret key of the settlement terminal 10 and authentication information specified by the terminal registration unit 1005 to thereby determine whether the portable terminal 20 is registered. If the portable terminal 20 not is successfully authenticated, the communication control unit 1007 disconnects the settlement terminal 10 from the portable terminal 20. The settlement terminal 10 ends the remote daily account processing.

If the portable terminal 20 was authenticated, the communication control unit 1007 generates a communication key from the random number data included in the certificate information 210 (Act 25).

The communication control unit 1007 transmits the communication key encrypted by the secret key of the settlement terminal 10 to the portable terminal 20 (Act 26).

The communication control unit 2003 of the portable terminal 20 decrypts the encrypted communication key with the public key of the settlement terminal 10 (Act 27). The communication control unit 2003 encrypts a daily account processing command with the decrypted communication key (Act 28). The communication control unit 2003 transmits the encrypted daily account processing command to the settlement terminal 10 (Act 29).

The communication control unit 1007 of the settlement terminal 10 executes authentication processing on the received daily account processing command (Act 30). For example, if the received daily account processing command can be decrypted by the communication key, the communication control unit 1007 authenticates the daily account processing command. In other words, the communication control unit 1007 authenticates the portable terminal 20 that transmitted the daily account processing command.

The daily account processing unit 1006 of the settlement terminal 10 executes daily account processing (Act 31). During the execution of the daily account processing, the display control unit 1002 may display an image indicating that the daily account processing is being executed. The printing control unit 1003 prints a processing result of the daily account processing (Act 32). During the printing of the processing result, the display control unit 1002 may display an image indicating that the processing result is being printed. During the execution of the daily account processing and the printing, the operation control unit 1001 may not receive operation.

The communication control unit 1007 transmits the daily account processing result encrypted by the communication key to the portable terminal 20 (Act 33). Accordingly, if the result display button G13 of the daily account processing selection screen G1 was pressed, the display control unit 2002 of the portable terminal 20 displays the execution result image G4 including the daily account processing result.

The communication control unit 2003 of the portable terminal 20 disconnects a line to the settlement terminal 10 by the TCP or the like (Act 34). The communication control unit 1007 of the settlement terminal 10 disconnects a line to the portable terminal 20 by the TCP or the like (Act 35).

The communication control unit 1007 of the settlement terminal 10 erases the communication key transmitted to the portable terminal 20 (Act 36). Then, the settlement terminal 10 ends the remote daily account processing.

The communication control unit 2003 of the portable terminal 20 erases the communication key received from the settlement terminal 10 (Act 37). Then, the portable terminal 20 ends the remote daily account processing.

As explained above, the settlement terminal operation system according to this embodiment includes the settlement terminal 10 and the portable terminal 20. The settlement terminal 10 includes the settlement processing unit 1004 that communicates with the settlement server included in the settlement management system 30 to thereby execute settlement for paying a price, the daily account processing unit 1006 that executes daily account processing for tallying settlements executed within a period by the settlement processing unit 1004, and the communication control unit 1007 that communicates with the portable terminal 20. If receiving operation for causing the settlement terminal 10 to execute the daily account processing, the portable terminal 20 transmits a daily account processing command for requesting execution of the daily account processing. As explained above, the portable terminal 20 can cause, with remote operation, the settlement terminal 10 to execute the daily account processing. Therefore, the settlement terminal operation system can reduce a burden on the daily account processing.

The embodiment is explained above. However, the embodiment is present as an example and is not intended to limit the scope of the invention. The embodiment can be implemented in other various forms. Various omissions, substitutions, and changes can be made without departing from the gist of the invention. The embodiment and modifications thereof are included in the scope and the gist of the invention and included in the scope of the inventions described in the claims and equivalents of the inventions.

Programs to be executed by the apparatuses in the embodiment and the modifications are provided by being incorporated, in advance, in storage media (ROMs or storage units) included in the apparatuses but are not limited to this. For example, the programs may be configured to be provided by being recorded in a computer-readable recording medium such as a CD-ROM, a flexible disk (FD), a CD-R, or a DVD (Digital Versatile Disk) as a file of an installable or executable format. Further, the recording medium is not limited to a medium independent of a computer or an embedded system and also includes a storage medium in which a program transmitted by a LAN, the Internet, or the like is downloaded and stored or temporarily stored.

The programs to be executed by the apparatuses in the embodiment and the modifications may be configured to be stored on a computer connected to a network such as the Internet and provided by being downloaded through the network or may be configured to be provided or distributed through the network such as the Internet.

What is claimed is:

1. A settlement terminal operation system, comprising:
a settlement terminal configured to execute settlement; and
a portable terminal configured to operate the settlement terminal,
the settlement terminal including:
a settlement processing component configured to execute, by communication with a settlement server, settlement for paying a price;
a daily account processing component configured to execute daily account processing for tallying settlements executed within a period by the settlement processing component; and
a first communication controller configured to execute communication with the portable terminal,
the portable terminal including:
an operation controller configured to receive operation for causing the settlement terminal to execute the daily account processing; and
a second communication controller configured to, if the operation is received by the operation controller, transmit a daily account processing command for requesting the execution of the daily account processing.

2. The settlement terminal operation system according to claim 1, wherein
the first communication controller transmits a processing result of the daily account processing, and
the portable terminal further includes a display controller configured to display the processing result on a display component.

3. The settlement terminal operation system according to claim 2, wherein the display controller displays a state of the daily account processing based on a communication log by the second communication controller.

4. The settlement terminal operation system according to claim 1, wherein the settlement terminal further includes a registration component configured to register the portable terminal having authority to cause the settlement terminal to execute the daily account processing.

5. The settlement terminal operation system according to claim 4, wherein
the portable terminal further includes a receiving component configured to receive information concerning the portable terminal having the authority to cause the settlement terminal to execute the daily account processing, and
the registration component registers the portable terminal specified by the information concerning the portable terminal received by the receiving component.

6. The settlement terminal operation system according to claim 1, wherein the portable terminal is a smartphone.

7. The settlement terminal operation system according to claim 1, wherein the portable terminal is a tablet terminal.

8. A method for a settlement terminal operation system, comprising:
executing settlement with a settlement terminal;
operating the settlement terminal a portable terminal;
executing, by communication with a settlement server with a settlement processing component, settlement for paying a price;
executing, using a daily account processing component, daily account processing for tallying settlements executed within a period by the settlement processing component;
executing, using a first communication controller, communication with the portable terminal;
receiving operation for causing the settlement terminal to execute the daily account processing by an operation controller; and
if the operation is received by the operation controller, transmitting a daily account processing command for requesting the execution of the daily account processing by a second communication controller.

9. The method according to claim 8, further comprising:
the first communication controller transmitting a processing result of the daily account processing; and
displaying the processing result.

10. The method according to claim 9, further comprising:
displaying a state of the daily account processing based on a communication log by the second communication controller.

11. The method according to claim 8, further comprising:
registering the portable terminal having authority to cause the settlement terminal to execute the daily account processing.

12. The method according to claim 11, further comprising:
receiving information concerning the portable terminal having the authority to cause the settlement terminal to execute the daily account processing; and
registering the portable terminal specified by the information concerning the portable terminal received.

13. A store account processing system, comprising:
a plurality of settlement terminals each configured to execute settlement; and
a portable terminal configured to operate the plurality of settlement terminals,
each settlement terminal including:
a settlement processing component configured to execute, by communication with a settlement server, settlement for paying a price;
a daily account processing component configured to execute daily account processing for tallying settlements executed within a period by the settlement processing component; and
a first communication controller configured to execute communication with the portable terminal,
the portable terminal including:
an operation controller configured to receive operation for causing the settlement terminal to execute the daily account processing; and
a second communication controller configured to, if the operation is received by the operation controller, transmit a daily account processing command for requesting the execution of the daily account processing.

14. The store account processing system according to claim 13, wherein
the first communication controller transmits a processing result of the daily account processing, and
the portable terminal further includes a display controller configured to display the processing result on a display component.

15. The store account processing system according to claim 14, wherein the display controller displays a state of the daily account processing based on a communication log by the second communication controller.

16. The store account processing system according to claim 13, wherein each settlement terminal further includes a registration component configured to register the portable terminal having authority to cause the settlement terminals to execute the daily account processing.

17. The store account processing system according to claim 16, wherein
the portable terminal further includes a receiving component configured to receive information concerning the portable terminal having the authority to cause the settlement terminals to execute the daily account processing, and
the registration component registers the portable terminal specified by the information concerning the portable terminal received by the receiving component.

18. The store account processing system according to claim 13, wherein the portable terminal is a smartphone.

19. The store account processing system according to claim 13, wherein the portable terminal is a tablet terminal.
